(19) United States
(12) Patent Application Publication
(10) Pub. No.: US 2022/0349865 A1
(43) Pub. Date: Nov. 3, 2022

(54) In-Line Measurement of Nitrite Content in Metalworking Fluids

(71) Applicant: Castrol Limited, Pangbourne,Reading (GB)

(72) Inventors: Axel Fuisting, Bochum (DE); Joachim Goertz, Hamburg (DE); Michael Loos, Bochum (DE)

(21) Appl. No.: 17/624,245

(22) PCT Filed: Jul. 1, 2020
(86) PCT No.: PCT/EP2020/068586

§ 371 Date: Dec. 30, 2021

(30) Foreign Application Priority Data
Jul. 2, 2019 (EP) 19183941.4

(51) Int. Cl. G01N 31/22; G01N 21/94; G01N 21/85

(52) U.S. Cl. CPC G01N 31/227; G01N 21/94; G01N 21/85; G01N 2001/205

(57) ABSTRACT

An apparatus for in-line monitoring of nitrite content in a metalworking fluid is provided, the apparatus comprising a sample inlet for receiving a sample of a metalworking fluid, a dilution inlet for receiving a dilution fluid, a reagent inlet for receiving a photoactive reagent, a reaction volume for containing a sample mixture in fluid communication with the sample inlet, dilution inlet and reagent inlet, a photometer for monitoring the sample mixture, and a flow control system for controlling fluid flow in the apparatus, to: selectively introduce the sample, the dilution fluid and/or the photoactive reagent from the respective inlets to the reaction volume to form the sample mixture, retain the sample mixture in the reaction volume and discharge the sample mixture from the reaction volume.

### FIELD OF THE INVENTION

The present invention relates to in-line measurement of nitrite content in metalworking fluids. In particular, the present invention relates to an apparatus and process for measuring the nitrite content of metalworking fluids by photometry.

### BACKGROUND

Metalworking fluids are used in workshops worldwide for the cutting and forming of metals. Their main purposes are to cool and lubricate tools, work pieces and machines, inhibit corrosion, remove swarf, and assist in the cutting, grinding and cleaning of metals. There are a variety of different types of metalworking fluids. Metalworking fluids, and aqueous metalworking fluids in particular, often contain nitrites, and in some instances it is necessary to measure the nitrite content of such fluids, for example to meet regulatory requirements.

Monitoring of the level of nitrites in metalworking fluids may be done by taking a sample of the fluid from the system to be monitored and evaluating the nitrite content in the laboratory. For example nitrite content may be monitored using test strips in a laboratory. However, such manual methods can be labour intense and therefore inefficient where regular testing is required.

There is a need for systems that can measure nitrite content in a more efficient way, and that can provide regular, real-time measurements of nitrite content of metalworking fluids without the need to extract and transport samples to a laboratory.

### SUMMARY

An aspect of the present invention provides an apparatus for in-line monitoring of nitrite content in a metalworking fluid, comprising:

a sample inlet for receiving a sample of a metalworking fluid;

a dilution inlet for receiving a dilution fluid;

a reagent inlet for receiving a photoactive reagent;

a reaction volume for containing a sample mixture in fluid communication with the sample inlet, dilution inlet and reagent inlet;

a photometer for monitoring the sample mixture; and

a flow control system for controlling fluid flow in the apparatus to:
(a) selectively introduce the sample, the dilution fluid and/or the photoactive reagent from the respective inlets to the reaction volume to form the sample mixture;
(b) retain the sample mixture in the reaction volume; and
(c) discharge the sample mixture from the reaction volume.

The apparatus can be used to provide in-line monitoring of metalworking fluids. It will be appreciated that in-line monitoring may comprise obtaining information about a sample obtained from a metalworking fluid that is concurrently or subsequently supplied to a metalworking process, a flow of used metalworking fluid or a combination thereof. For example the apparatus may be used for automated monitoring of nitrite content in a metalworking fluid source. In-line monitoring may comprise diverting a sample of metalworking fluid from a process flow to the sample inlet of the apparatus, for example in use the apparatus may be arranged so that the sample inlet is in fluid communication with a metalworking fluid process flow. Diverting a sample of a metalworking fluid process flow may comprise obtaining a sample from a metalworking fluid process flow that is actively being used in a metalworking process, or may comprise obtaining a sample from a source of metalworking fluid that is to be used in a metalworking process, for example a source of metalworking fluid from which a metalworking fluid process flow is drawn.

The sample of metalworking fluid may be obtained directly from a metalworking fluid process flow or may be obtained indirectly, for example from a pre-sampled volume or flow of the metalworking fluid that may be collected for providing samples of the metalworking fluid to one or more other monitoring apparatuses in addition to the present apparatus.

In some instances, the apparatus may be arranged to receive a sample of metalworking fluid at the sample inlet and to return a flow of the metalworking fluid through an outlet. For example, the sample inlet may comprise a sampling loop through which a flow of metalworking fluid can be passed, where a sampling volume of metalworking fluid can be contained in the sampling loop, for example between two valves. The sampling volume may comprise a defined volume, where a sample comprising the entire sampling volume is provided into the reaction volume. Alternatively, the sampling volume may be larger than the volume of sample provided into the reaction volume.

The sample inlet may comprise one or more filters, for example for removing components of the sample such as particulate material that could damage the apparatus. The sample inlet may for example comprise a 5 to 30 μm filter, for example a 10 μm filter.

The metalworking fluid may be any type of metalworking fluid known in the art such as: (1) non-water-miscible oils, (2) water-miscible oils, and (3) fully synthetic oil-free products. Accordingly, the metalworking fluids may be oil based, aqueous based, a water-in-oil emulsion, or an oil-in-water emulsion. If the metalworking fluid is an oil-in-water or water-in-oil emulsion, the metalworking fluid may also comprise an emulsifier to aid in formation of the oil-in-water emulsion or water-in-oil emulsion.

The metalworking fluid may suitably further comprise one or more additives such as those typically found in metalworking fluids. Such additives will be known and familiar to the person skilled in the art. Typical additives for use in metalworking fluids include corrosion inhibitors, pH modifying additives, biocides, surfactants, antioxidants, yellow metal inhibitors, extreme pressure (EP) additives, anti-wear (AW) additives, boundary lubricating additives and combinations thereof.

The metalworking fluid may be used in grinding and honing applications as a grinding oil, as cutting oil or broaching oil, in deformation metalworking applications such as in evaporating stamping fluids. The metalworking fluid may be used as water-miscible metalworking fluid.

The dilution inlet may suitably be connected to a source of dilution fluid. The source of dilution fluid may be an external source, for example where in use an external source is connected to the dilution inlet. In some instances, the source of dilution fluid may comprise an internal source of dilution fluid, for example where the apparatus comprises a dilution fluid reservoir for storing a dilution fluid. The dilution fluid may be any suitable fluid and the particular dilution fluid may suitably be selected based on the metalworking fluid to be monitored. In particular, the dilution fluid may be water.

The reagent inlet may suitably be connected to one or more external or internal sources of the photoactive reagent, where the photoactive reagent may comprise a mixture of one or more components. The reagent inlet may comprise more than one separate inlet for providing components of the photoactive reagent separately. The apparatus may comprise one or more reservoirs for storing the photoactive reagent or one or more components thereof, and/or one or more components of the photoactive material may in use be provided from an external source.

The photoactive reagent may comprise any suitable reagent for reacting with nitrite ions in the sample to provide a species that can be observed using the photometer. The reaction of the photoactive reagent with the nitrite ions may produce a colour change that can be measured using the photometer. By way of example, the photoactive reagent may comprise sulfanilamide and N-(1-naphthyl)ethylenediamine (Griess reagent), which may be combined with the sample in acidic medium, and the nitrite content of the sample mixture may be monitored by measuring the absorption at a wavelength of 525 nm using the photometer and calculating nitrite concentration in the sample using a set calibration function. The reagent may comprise sulfanilamide and N-(1-naphthyl)ethylenediamine in an acidic medium, for example in an aqueous acidic solution such as a phosphoric acid solution, which may be provided to the reaction volume through a single reagent inlet. In some instances at least one of an acid, sulfanilamide and N-(1-naphthyl)ethylenediamine may be provided separately to the reaction volume, for example through separate reagent inlets. In some instances, the sample may be suitably acidic prior to introduction into the apparatus and mixing with the photoactive reagent.

The reaction volume may comprise a volume defined by one or more flow paths between the respective inlets for introducing fluids into the apparatus and one or more outlets for discharging fluids from the apparatus. The reaction volume may comprise a reaction vessel and one or more flow paths in fluid communication with the reaction vessel. The flow control system for retaining the sample mixture in the reaction volume in part (b) may comprise a valve operable to provide a closed flow path within the reaction volume, and may comprise a pump operable to circulate the sample mixture within the reaction volume, for example the first pump described herein.

It will be appreciated that flow paths within the apparatus may be provided by any suitable means, for example flow paths within the apparatus may be provided by one or more conduits for containing the sample mixture.

The sample mixture, as referred to herein will be understood to refer to any combination of fluids present in the reaction volume, for example one of the sample, the dilution fluid or the photoactive reagent or a combination of one or more of said fluids.

The reaction volume may comprise a reaction vessel and a photometer flow path for providing the sample mixture from the reaction vessel to the photometer. The photometer may be arranged to monitor the sample mixture in a separate photometer flow path in fluid communication with the reaction vessel, or the photometer may be arranged to monitor the sample mixture in the reaction vessel, for example where the reaction vessel comprises the photometer flow path. The photometer flow path may comprise a flow path fluidly connected to the reaction vessel at both ends of the flow path, for example so that the photometer is arranged to monitor the sample mixture at a position along a flow path that begins and ends at the reaction vessel.

The photometer may comprise an inlet and an outlet defining a flow path for the sample mixture through the photometer in which the sample mixture is monitored. In some instances a conduit defining the photometer flow path, or the reaction vessel may comprise a window through which the photometer can monitor the sample mixture.

The photometer may comprise any suitable photometer for monitoring absorption at a wavelength absorbed due to the reaction of the photoactive reagent with nitrite ions in the sample, and it will be appreciated that such photometers will be known to a person skilled in the art.

The flow control system may comprise one or more pumps and one or more valves operable for controlling fluid flow in the apparatus.

The flow control system may comprise a first pump for providing the sample mixture from the reaction vessel to the photometer flow path, and for discharging the sample mixture from the reaction vessel. Where the first pump provides the sample mixture to the photometer flow path, this may comprise circulating the sample mixture within the reaction volume. The flow control system may comprise a first valve for selecting whether the first pump provides the sample mixture to the photometer flow path, or discharges the sample mixture from the reaction volume. For example, the first valve may be positioned downstream of the first pump and operable to connect a flow path from the first pump to the photometer flow path or to an outlet of the apparatus.

The flow control system may comprise a second valve for selecting whether the sample mixture is discharged from the reaction vessel and/or the photometer flow path. For example the second valve may be positioned upstream of the first pump and operable to selectively connect the reaction vessel and/or the photometer flow path to an inlet of the first pump. Where the reaction vessel is connected to an inlet of the first pump, for example by operation of the second valve, a first valve may be operable to direct sample mixture from the reaction vessel to an outlet of the apparatus or to the photometer flow path as described previously. For example the first pump may be arranged to circulate the sample mixture through the reaction vessel and the photometer flow path.

The flow control system may comprise a sample pump for introducing the sample into the reaction volume, a dilution pump for introducing the dilution fluid into the reaction volume, and/or a reagent pump for introducing the photoactive reagent into the reaction volume. The sample inlet, dilution inlet and reagent inlet may each optionally comprise one or more valves for controlling flow from the respective inlet to a respective pump and/or the reaction volume.

Where the reagent inlet comprises more than one reagent inlet for providing components of the photoactive reagent separately, the flow control system may include a reagent pump for each respective inlet, or a multi-channel pump connected to more than one reagent inlet.

It will be appreciated that where a fluid input into an inlet of the apparatus is provided at a higher pressure than the pressure in the reaction volume, a valve may be used to control supply of the fluid into the reaction volume, optionally in combination with a pump. Alternatively, where a fluid input into an inlet of the apparatus is not pressurised, a pump may be used to control supply of the fluid into the reaction volume, optionally in combination with a valve.

Two or more pumps for introducing fluids into the reaction volume may be provided by a single multichannel pump having separate flow paths through the pump, for example a dual channel pump. The channels of a multichannel pump may be configured to provide a pre-defined volumetric flow rate through each channel, for example an equivalent volumetric flow rate through each channel.

A multichannel pump may provide additional pumping functionality to the sample pump, dilution pump, and reagent pump. For example the sample pump may comprise a multichannel pump, for example a multichannel pump for introducing the sample and the dilution fluid into the reaction volume at the same time, for example a dual channel pump in fluid communication with the sample inlet and the dilution inlet.

The reaction volume may comprise a first discharge flow path for discharging the sample mixture from the reaction volume and a second discharge flow path for only partially discharging the sample mixture from the reaction volume to leave a pre-defined volume of the sample mixture in the reaction volume. For example the reaction vessel may comprise a first outlet and a second outlet, where the second outlet is arranged to only partially discharge sample mixture from the reaction vessel. The volume of a fluid introduced into the reaction volume may therefore be controlled, for example by introducing a volume of fluid to the reaction volume and reducing the volume to a particular level by discharging sample mixture.

The flow control system may comprise a third valve for selecting whether the sample mixture is discharged through the first or second discharge flow path of the reaction volume. For example the first and second discharge flow paths may be connected to the third valve.

The first pump may be arranged to discharge the sample mixture through the first and second discharge flow paths. For example, the first and second discharge flow paths may be fluidly connected to an inlet of the first pump. For example, the third valve may be fluidly connected to an inlet of the first pump, and may be connected to an inlet of the first pump via the second valve.

The apparatus may comprise a calibration outlet through which the sample that is introduced into the apparatus can be extracted to perform offline measurements for calibrating the apparatus. The flow control system may comprise a valve for selecting whether the sample is directed to the calibration outlet or into the reaction volume.

The apparatus may further comprise a controller configured to operate the apparatus to:
(i) provide a first volume of the sample of a metalworking fluid to be tested from the sample inlet into the reaction volume;
(ii) provide a second volume of the dilution fluid from the dilution inlet into the reaction volume to form a diluted sample mixture;
(iii) provide a third volume of the photoactive reagent from the reagent inlet into the reaction volume to form an activated sample mixture; and
(iv) obtain a photometry measurement of the activated sample mixture using the photometer, wherein the photometry measurement provides an indication of the nitrite content of the sample.

The controller may be configured to synchronise operation of one or more valves and one or more pumps of the fluid control system to control fluid flow in the apparatus. For example, the controller may be configured to synchronise operation of the first pump with operation of the first, second and/or third valve to control flow in the apparatus.

The first, second and third volumes of the sample, the dilution fluid and the photoactive reagent respectively may be introduced into the reaction volume by for example, timing operation of a pump coupled to the respective inlet to introduce each volume of fluid, for example timing operation of the sample pump, the dilution pump or the reagent pump. Timing operation of a pump may comprise operating the pump for a set duration of time. The timing of the pump operation may for example be based on a known or set volumetric flow rate provided by the pump. Controlled volumes of fluid may also be introduced into the reaction volume by timing opening of a valve at the respective inlet to allow a set volume of fluid to flow through the valve. A fixed volume of fluid may be provided by trapping the fluid in a volume between two or more valves. In some instances, a fixed volume of fluid may be provided by introducing a volume of fluid into the reaction volume and then partially discharging the reaction volume to leave a set volume of fluid.

The valves present in the apparatus may comprise any suitable valves known in the art, and may for example comprise solenoid valves or ball valves. The valves may suitably comprise multiway valves, for example three way valves or on/off valves as required. The valves may suitably comprise normally closed or normally open valves, and a three way valve may comprise both a normally open and a normally closed flow path through the valve. The valves may suitably be automatically operable, for example where the valves comprise solenoid valves, or where the valves comprise electronically operable valve actuators. For instance the valves may be operable by the controller, which may control the timing and duration of opening of the valves.

The pumps present in the apparatus may comprise any suitable pumps and may comprise single or multi-channel pumps. The pumps may comprise positive displacement pumps such as rotary gear or vane pumps, peristaltic pumps or diaphragm pumps. The pumps may suitably be automatically operable, for example operable by the controller, which may control the timing and duration of opening of the valves.

A valve or pump described as a valve or pump for performing a function may suitably be considered as being operable to or arranged to perform said function, or vice versa. Operating a valve to perform a particular function as described herein may in some instances comprise taking no action to change the flow through the valve, for example where a valve is already in the desired configuration as may be the case with a normally open valve in the desired configuration.

Although the valves and/or pumps described herein may be referred to as first, second, third etc., these may be considered merely as labels and do not imply a sequence or dependence of one component on the others. The apparatus may suitably comprise one or any combination of more than one of the valves or pumps described independently of the others.

The controller may suitably be configured to operate a multichannel pump to introduce at least a portion of the first, second and/or third volumes of the respective fluids to the reaction volume at the same time. For example, the controller may be configured to operate a dual channel pump to introduce the first volume of the sample to the reaction volume at the same time as a portion of the second volume of the dilution fluid, and to operate a separate dilution pump to introduce only the dilution fluid to provide the remaining portion of the second volume of dilution fluid.

The controller may be configured to operate the apparatus to provide the first volume by introducing a volume of the sample greater than the first volume into the reaction volume, and discharging sample mixture from the reaction volume to leave the first volume of the sample.

The controller may be configured to operate the apparatus to circulate the diluted sample mixture and/or the activated sample mixture within the reaction volume. For example, circulating the sample mixture within the reaction volume may aid in mixing the components of the sample mixture and ensuring homogeneous distribution through the reaction volume.

In some embodiments, providing the second volume of dilution fluid and/or providing the third volume of photoactive reagent, is at least in part simultaneous with the circulating of the diluted sample mixture and/or the activated sample mixture within the reaction volume respectively.

Obtaining a photometry measurement of the activated sample mixture may comprise obtaining a photometry measurement of a substantially static sample mixture in the reaction volume. For example, the controller may control pumps and/or valves so that the sample mixture does not actively flow through the photometer, for example by switching off the pumping by one or more pumps of the apparatus.

The controller may be configured to obtain a photometry measurement of the diluted sample mixture before introducing the photoactive reagent. For example, the first volume of the sample and the second volume of the dilution fluid may be introduced to the reaction volume and a photometry measurement obtained of the diluted sample mixture as a background measurement. The controller may then operate the apparatus to introduce the third volume of the photoactive reagent into the reaction volume before obtaining a photometry measurement of the activated sample and may then compare that measurement against the background measurement to provide an indication of the nitrite content of the sample.

The controller may be configured to periodically obtain measurements that provide an indication of the nitrite content of different samples of metalworking fluids. For example, the controller may be configured to operate the apparatus to automatically obtain a measurement of nitrite content of a sample at pre-determined time intervals, such that a measurement of the nitrite content of a source of metalworking fluid may be monitored over time. The controller may be configured to, between measurements, operate the apparatus to empty the reaction volume of sample mixture and/or to flush the apparatus with dilution fluid and/or the sample.

The controller may be configured to operate the apparatus to perform a sequence comprising:
optionally emptying the reaction volume or the reaction vessel;
   rinsing the reaction volume with dilution fluid and/or a sample of metalworking fluid and discharging fluids from the reaction volume to empty the reaction volume;
   introducing the sample to the reaction volume and optionally reducing the volume of sample to provide the first volume;
   introducing the dilution fluid to the reaction volume to dilute the sample;
   circulating the sample mixture within the reaction volume;
   obtaining a background photometry measurement of the sample mixture;
   introducing the photoactive reagent into the reaction volume and circulating the sample mixture within the reaction volume;
obtaining a photometry measurement of the sample mixture; and
optionally comparing photometry measurement against the background measurement to determine the nitrite content of the sample.

The controller may be configured to record the photometry measurement and/or nitrite content of the sample in a database, for example to provide an entry in the database indicating the time of the measurement and the nitrite content or data that provides an indication of the nitrite content, for example photometry measurement data. The controller may alternatively or additionally be configured provide an indication when the nitrite content of the sample is outside a threshold range. For example the controller may be configured to provide an indication to a user in real time by providing the indication visually on a display, or by providing an electronic notification to a user, for example providing an email or a notification to a work station or a mobile device.

The controller may be configured to provide an indication and/or a control signal to adjust the nitrate content of a metalworking fluid based on the indication of the nitrite content of the sample. For example, the controller may be connected in a feedback loop, whereby in the event that the nitrite content measured is outside a threshold range, the controller is configured to provide a control signal to adjust the nitrite content of the source of metalworking fluid from which the sample is obtained. Providing the control signal may be based on more than one separate measurement that the nitrite content of a metalworking fluid is outside a threshold range.

A further aspect of the invention provides a method for in-line monitoring of nitrite content in metalworking fluids using an apparatus as defined previously herein, the method comprising:

(i) withdrawing a sample of a metalworking fluid to be tested from a metalworking fluid stream and providing a first volume of the sample from the sample inlet into the reaction volume;

(ii) providing a second volume of a dilution fluid from the dilution inlet into the reaction volume to form a diluted sample;

(iii) providing a photoactive reagent from the reagent inlet into the reaction volume to form an activated sample; and

(iv) obtaining a photometry measurement of the activated sample, wherein the photometry measurement provides an indication of the nitrite content of the sample.

The dilution fluid, the metalworking fluid and the photoactive reagent may be substantially as defined previously herein.

It will be appreciated that the method may comprise operating the apparatus to perform the steps for which the controller described herein is configured.

A further aspect of the invention provides a computer program product comprising program instructions configured to program a computer system to perform the methods described herein.

A further aspect of the invention provides a control system for an apparatus as defined previously herein, comprising a processor and computer memory comprising said program instructions configured to program a computer system to perform the methods described herein.

A further aspect of the invention provides a metalworking fluid delivery system for providing a metalworking fluid to a metalworking process, comprising a control system and/or an apparatus as described herein.

A further aspect of the invention provides a method of retrofitting a metalworking fluid delivery system by providing the system with an apparatus and/or a control system as described herein.

A further aspect of the invention provides the use of an apparatus as described herein to automatically monitor, and optionally record, the nitrite content of a metalworking fluid periodically, for example at pre-defined time intervals.

### BRIEF DESCRIPTION OF THE FIGURES

The present invention will now be described by way of example and with reference to the accompanying FIGURE in which:

FIG. 1 illustrates an example of an apparatus for in-line monitoring of nitrite content in a metalworking fluid.

### SPECIFIC DESCRIPTION

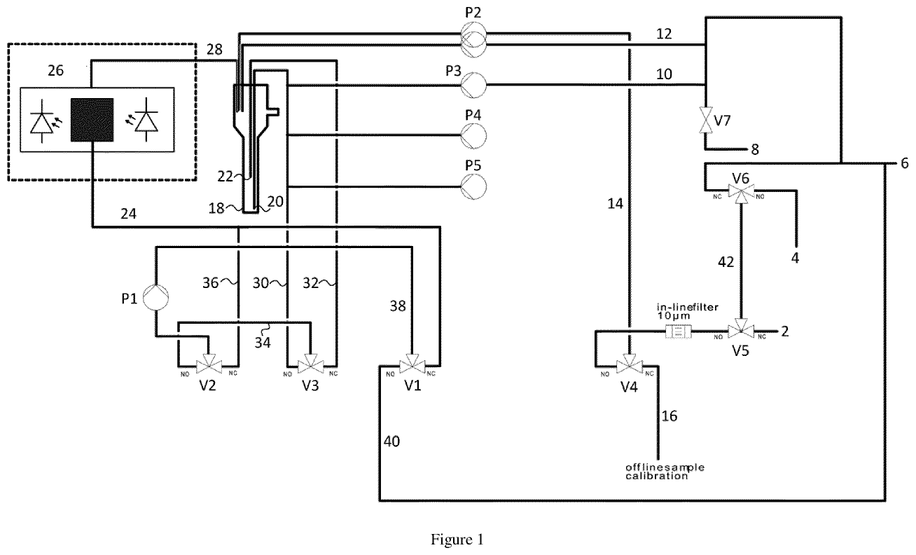

FIG. 1 shows a schematic representation of an example apparatus in which sample inlet 2, which is in use connected to a source of metalworking fluid to be monitored, is connected via valve V5 to sampling volume/flow path 42, which is connected via valve V6 to a vent 4 and an outlet 6, which may be arranged as a return line to return fluids to the source of metalworking fluid from which the sample is obtained. Valves V5 and V6 are operable to hold a volume of sample in the sample volume 42.

An inline filter separates valve V5 from calibration valve V4, which is operable to direct the sample via flow path 16 for offline calibration, or to direct the sample via flow path 14. Flow path 14 is connected via dual channel sample pump P2 to an inlet of reaction vessel 18. Therefore, the dilution fluid may be introduced by pump P2 into the reaction vessel 18 at the same time as the sample.

Dilution inlet 8 is connected to a source of dilution fluid, for example water, and the dilution inlet 8 may be opened or closed by operating a valve V7. The dilution inlet 8 is connected via flow path 12 and the dual channel sample pump P2 to an inlet of reaction vessel 18. The dilution inlet is also connected via flow path 10 and dilution pump P3 to a flow path 30 from a first outlet 20 of the reaction vessel, whereby dilution fluid can be introduced into the reaction volume independently of the sample.

Reagent pump P4 and optional second reagent pump P5 are also connected to flow path 30 for introducing photoactive reagent into the reaction volume. Reagent pumps P4 and P5 may be connected to respective reagent reservoirs for storing the photoactive reagent or components thereof.

Reaction vessel 18 comprises an outlet 20 that is connected via flow path 30, third valve V3, flow path 34, and second valve V2 to an inlet of first pump P1. The outlet of the first pump P1 is connected by flow path 38 to a first valve V1, where the first valve V1 is connected, via flow path 40 to the outlet 6. Thus, the first pump may be operated to discharge sample mixture from the reaction vessel through the outlet 6.

The first valve V1 is also connected to photometer flow path 24 comprising a photometer 26 arranged to monitor fluids that are provided to the photometer 26 by the photometer flow path 24. The photometer flow path 24 comprises a flow path 28 that connects to an inlet of the reaction vessel 18. Thus, the first pump P1 may be operated to circulate the sample mixture from an outlet 20 of the reaction vessel 18, via the photometer 26 and back to the reaction vessel 18 via flow path 28.

Second valve V2 is additionally connected directly to the photometer flow path 24 via flow path 36. Thus the photometer flow path 24 may be connected via the second valve V2 to an inlet of the first pump P1, and the first pump may be operated to discharge sample mixture in the photometer flow path through the outlet 6 via first valve V1.

The reaction vessel 18 comprises a second outlet 22, which is connected via a flow path 32 to the third valve V3. The second outlet 22 is arranged to only partially withdraw sample mixture that is present in the reaction vessel 18. Thus, third valve V3 is operable to select which of the first outlet 20 and second outlet 22 of the reaction vessel 18 are connected via first pump P1 to the outlet 6.

Although not shown in FIG. 1, the components of the apparatus shown in FIG. 1 may be connected to a controller configured to control flow within the apparatus and operation of the photometer. With reference to the apparatus of FIG. 1, an example of the operation of the apparatus in use will be described.

Valves V5 and V6 may be operated to connect sample inlet 2 to outlet 6 so as to flush sample through the sampling volume 42. Valves V5 and V6 are then closed to retain a sample to be monitored in sampling volume 42.

Before introducing the sample mixture into the reaction vessel 18, the reaction vessel 18 may first be emptied by operating the valves V1, V2 and V3 to connect the first outlet 20 of the reaction vessel 18 to the outlet 6 via flow paths 30, 34, 38 and 40, and operating the first pump P1 to discharge sample mixture from the reaction vessel 18 to the outlet 6.

The apparatus may then be flushed with fresh sample mixture by introducing sample from sampling volume 42 to the reaction vessel via flow path 14 by operating valves V5 and V4 and sample pump P2, and at the same time introducing dilution fluid from dilution inlet 8 via flow path 12 by operating valve V7 and pump P2. In general, when sample is introduced into the reaction vessel from sampling volume 42, valve V6 may be operated to open to vent 4. The sample mixture is also circulated from the first outlet 20 back into the reaction vessel 18 via flow paths 30, 34, 38, 24 and 28 by operating valves V1, V2 and V3 and pump P1, and sample mixture may also be discharged through flow path 40 to the outlet 6. Following this, the reaction vessel 18 may be emptied of sample mixture as described previously.

A partially diluted sample mixture is introduced into the reaction vessel 18 from sample volume 42 by operating valves V5 and V4 and sample pump P2 to introduce sample along flow path 14, and at the same time introducing dilution fluid from dilution inlet 8 via flow path 12 by operating valve V7 and pump P2.

The volume of partially diluted sample mixture in the reaction vessel 18 is then controlled by operating valves V3, V2 and V1 to connect second outlet 22 to outlet 6 via flow paths 32, 34, 38 and 40 and operating the first pump P1 to partially discharge the partially diluted sample mixture from the reaction vessel.

Dilution fluid from dilution inlet 8 is then introduced via flow path 10 by opening valve V7 and operating dilution pump P3. The dilution fluid is provided to the reaction vessel 18 via flow paths 30, 34, 38, 24 and 28, and at the same time the diluted sample in the reaction vessel 18 may be circulated from the first outlet 20 to the flow path 28 by the same flow path as the dilution fluid introduced from flow path 10.

The diluted sample mixture may then be homogenised by circulating the diluted sample within the reaction volume from the first outlet 20 of the reaction vessel 18, via the photometer 26 and back into the reaction vessel 18 via flow paths 30, 34, 38, 24 and 28, by operating valves V1, V2 and V3 and pump P1.

The pump P1 is turned off to stop the circulation of the diluted sample to provide a substantially static sample at the photometer 26, and the photometer 26 is operated to obtain a background photometry measurement of the diluted sample.

The reagent pump P4 is then operated to provide the photoactive reagent to flow path 30, and the sample mixture circulated from first outlet 20 to flow path 28 as described previously, to provide the photoactive reagent to the reaction vessel 18. Where present, the reagent pump P5 may be operated in substantially the same way to introduce a second component of the photoactive reagent and this may be done simultaneously or sequentially with respect to introduction of a first component of the photoactive reagent using pump P4.

The sample mixture may then be homogenised to form the activated sample mixture by circulating the sample mixture including the photoactive reagent within the reaction volume from the first outlet 20 of the reaction vessel 18, via the photometer 26 and back into the reaction vessel 18 via flow paths 30, 34, 38, 24 and 28, by operating valves V1, V2 and V3 and pump P1.

The pump P1 is turned off to stop the circulation of the activated sample mixture and the photometer 26 is operated to obtain a photometry measurement of the activated sample.

The photometry measurement and the background measurement may be recorded in a database along with the time, for example the date, that it was measured and/or with another identifier for the metalworking fluid that was sampled and measured such as a batch identifier. The photometry measurement and the background measurement may be compared to provide an indication of the nitrite concentration in the sample, and the nitrite concentration in the sample may be recorded instead of or in addition to the photometry measurements. The nitrite concentration may be determined in real time with the collection of the photometry measurements, and an alert signal recorded or sent to a user in real time if the nitrite concentration is outside a threshold range. An indication of a nitrite concentration outside a threshold range may alternatively or additionally trigger a control signal to adjust the nitrite content of the metalworking fluid source from which the sample was taken. The threshold range for issuing an alert signal may be different from the threshold range for triggering a control signal, for example the threshold range for issuing an alert may be narrower (in respect of the upper and/or lower limits) than the threshold range for issuing a control signal. An alert signal or control signal may in some cases only be issued based on more than one measurement, for example at least two measurements taken sequentially, where a first nitrite content measurement outside the threshold range may trigger a second measurement, where the trigger to issue an alert or control signal is dependent on both measurements. Alternatively or additionally, the more than one measurement may comprise more than one measurement taken at periodic time intervals, for example so that the measurements can be analysed to determine the presence of a pattern of nitrite contents outside a threshold range over time.

It will be appreciated that the volume of sample, dilution fluid and photoactive reagent introduced to the reaction volume will be set so that concentration of nitrites in sample can be calculated from the absorbance measured by the photometer, for example using a previously determined calibration function. The exact volumetric ratio of the different components and the total volume may suitably vary based on the particular system. In one example, where for example the dilution fluid is water and the photoactive reagent comprises sulfanilamide and N-(1-naphthyl) ethylenediamine, about 1 to 2 ml of sample, about 40 ml of water, and about 5 ml of photoactive reagent solution may be introduced into the reaction volume for measurement. Following a measurement, the photometer flow path 24, including the photometer 26 and flow path 28, may be emptied of sample mixture by operating second valve V2 to connect the photometer flow path 24 to the inlet of the first pump P1 via flow path 36, and operating first valve V1 to connect flow path 38 to flow path 40 and the outlet 6. The reaction vessel 18 may also be emptied of sample mixture by operating the valves V1, V2 and V3 to connect the first outlet 20 of the reaction vessel 18 to the outlet 6 via flow paths 30, 34, 38 and 40, and operating the first pump P1 to discharge sample mixture from the reaction vessel 18 to the outlet 6.

Finally, the reaction volume may be rinsed with dilution fluid by introducing dilution fluid via flow path 10 by opening valve V7 and operating dilution pump P3. The dilution fluid is provided to the reaction vessel 18 via flow paths 30, 34, 38, 24 and 28, and at the same time the dilution fluid is circulated from the first outlet 20 of the reaction vessel 18 to the flow path 28 by the same flow path as the dilution fluid introduced to the reaction vessel 18 from flow path 10. The reaction vessel 18 and the photometer flow path 24 may then be emptied as described previously, and the cycle of rinsing and emptying the reaction volume repeated, for example repeated three times, with the final emptying step performed either immediately or before performing a further sample measurement.

In certain examples a controller described herein may be configured to perform any of the methods, or particular steps of said methods. A controller described herein may refer to a single controller and/or processor or control may be distributed between multiple controllers and/or processors, which may physically form part of the apparatus or may be a remote controller communicatively coupled to the apparatus. The activities and apparatus outlined herein may be implemented using controllers and/or processors which may be provided by fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Other variations and modifications of the apparatus will be apparent to persons of skill in the art in the context of the present disclosure.

1. An apparatus for in-line monitoring of nitrite content in a metalworking fluid, comprising:
a sample inlet for receiving a sample of a metalworking fluid;
a dilution inlet for receiving a dilution fluid;
a reagent inlet for receiving a photoactive reagent;
a reaction volume for containing a sample mixture in fluid communication with the sample inlet, dilution inlet and reagent inlet;
a photometer for monitoring the sample mixture; and
a flow control system for controlling fluid flow in the apparatus to:
(a) selectively introduce the sample, the dilution fluid or the photoactive reagent from the respective inlets to the reaction volume to form the sample mixture;
(b) retain the sample mixture in the reaction volume; and
(c) discharge the sample mixture from the reaction volume.

2. The apparatus of claim 1, wherein the reaction volume comprises a reaction vessel and a photometer flow path for providing the sample mixture from the reaction vessel to the photometer.

3. The apparatus of claim 2, wherein the flow control system comprises a first pump for providing the sample mixture from the reaction vessel to the photometer flow path, and for discharging the sample mixture from the reaction vessel.

4. The apparatus of claim 3, wherein the flow control system comprises a first valve for selecting whether the first pump provides the sample mixture to the photometer flow path, or discharges the sample mixture from the reaction volume.

5. The apparatus of claim 2, wherein the flow control system comprises a second valve for selecting whether the sample mixture is discharged from the reaction vessel or the photometer flow path.

6. The apparatus of claim 1, wherein the flow control system comprises a sample pump for introducing the sample into the reaction volume, a dilution pump for introducing the dilution fluid into the reaction volume, or a reagent pump for introducing the photoactive reagent into the reaction volume.

7. The apparatus of claim 1, wherein the reaction volume comprises a first discharge flow path for discharging the sample mixture from the reaction volume and a second discharge flow path for only partially discharging the sample mixture from the reaction volume to leave a pre-defined volume of the sample mixture in the reaction volume.

8. The apparatus of claim 7, wherein the flow control system comprises a t valve for selecting whether the sample mixture is discharged through the first or second discharge flow path.

9. The apparatus of claim 7, wherein the first pump is arranged to discharge the sample mixture through the first and second discharge flow paths.

10. The apparatus of claim 6, wherein the sample pump comprises a multichannel pump for introducing the sample and the dilution fluid into the reaction volume at the same time, for example a dual channel pump in fluid communication with the sample inlet and the dilution inlet.

11. The apparatus of claim 1 further comprising a controller configured to operate the apparatus to:
(i) provide a first volume of the sample of a metalworking fluid to be tested from the sample inlet into the reaction volume;
(ii) provide a second volume of the dilution fluid from e dilution inlet into the reaction volume to form a diluted sample mixture;
(iii) provide a third volume of the photoactive reagent from the reagent inlet into the reaction volume to form an activated sample mixture; and
(iv) obtain a photometry measurement of the activated sample mixture using the photometer, wherein the photometry measurement provides an indication of the nitrite content of the sample.

12. The apparatus of claim 11, wherein the controller is configured to operate the apparatus to provide the first volume by introducing a volume of the sample greater than the first volume into the reaction volume, and discharging metalworking fluid from the reaction volume to leave the first volume of the sample.

13. The apparatus of claim 11, wherein the controller is configured to operate the apparatus to circulate the diluted sample mixture and/or the activated sample mixture within the reaction volume.

14. The apparatus of claim 13, wherein providing the second volume of dilution fluid and/or providing the third volume of photoactive reagent, is at least in part simultaneous with the circulating of the diluted sample mixture and/or the activated sample mixture within the reaction volume respectively.

15. The apparatus of claim 1, wherein the controller is configured to obtain a photometry measurement of the diluted sample mixture before introducing the photoactive reagent.

16. The apparatus of claim 11, wherein the controller is configured to periodically obtain measurements that provide an indication of the nitrite content of different samples of metalworking fluids.

17. The apparatus of claim 16, wherein between measurements the controller is configured to operate the apparatus to empty the reaction volume of sample mixture and/or to flush the apparatus with dilution fluid or the sample.

18. The apparatus of claim 11, wherein the controller is configured to record the photometry measurement or nitrite content of the sample in a database, or to provide an indication when the nitrite content of the sample is outside a threshold range.

19. The apparatus of claim 11, wherein the controller is configured to provide an indication and/or a control signal to adjust the nitrate content of a metalworking fluid based on the indication of the nitrite content of the sample.

20. A method for in-line monitoring of nitrite content in metalworking fluids using an apparatus as defined in claim 1, the method comprising:
(i) withdrawing a sample of a metalworking fluid to be tested from a metalworking fluid stream and providing a first volume of the sample from the sample inlet into the reaction volume;
(ii) providing a second volume of a dilution fluid from the dilution inlet into the reaction volume to form a diluted sample;
(iii) providing a photoactive reagent from the reagent inlet into the reaction volume to form an activated sample; and
(iv) obtaining a photometry measurement of the activated sample, wherein the photometry measurement provides an indication of the nitrite content of the sample.

21. The method of claim 20, wherein the dilution fluid is water and the metalworking fluid is an aqueous metalworking fluid, and/or wherein the photoactive reagent comprises sulfanilamide and N-(1-naphthyl)ethylenediamine.

22. The method of claim 20, wherein the apparatus further comprises a controller, and wherein the method comprises the controller operating the apparatus.

23. A computer program product comprising program instructions configured to program a computer system to perform the method of claim 20.

24. A control system for an apparatus, comprising a processor and computer memory comprising program instructions according to claim 23.

25. Use of an apparatus according to claim 1 for automatically monitoring, and optionally recording, the nitrite content of a metalworking fluid periodically.
